(19) United States
(12) Patent Application Publication
(10) Pub. No.: US 2009/0053382 A1
(43) Pub. Date: Feb. 26, 2009

(54) Method of Processing Chlorogenic Acid-Rich Coffee Beans

(76) Inventors: Mineko Kawamura, Osaka (JP); Yoshiteru Ishikawa, Hyogo (JP); Koichi Nakahara, Osaka (JP)

Correspondence Address: DRINKER BIDDLE & REATH (DC), 1500 K STREET, N.W., SUITE 1100, WASHINGTON, DC, 20005-1209, US

(21) Appl. No.: 11/883,157

(22) PCT Filed: Jan. 25, 2006
(86) PCT No.: PCT/JP2006/301110

§ 371 Date: Apr. 4, 2008

(30) Foreign Application Priority Data
Jan. 28, 2005 (JP) 2005-022198

(51) Int. Cl. A23F 5/04; A23F 5/00

(52) U.S. Cl. 426/595; 426/467

(57) ABSTRACT

A method of processing coffee beans in which green coffee beans are roasted and roasted coffee beans are obtained, wherein the green coffee beans are brought into contact with a high-temperature, high-pressure fluid and the roasting process is performed.

### TECHNICAL FIELD

The present invention relates to a method of processing coffee beans for roasting green coffee beans and obtaining roasted coffee beans.

### BACKGROUND ART

The components that are the essence of the characteristic tastes and aromas of coffee (referred to as “coffee flavor components” hereinafter) are generated from the progression of complex, continuous chemical reactions that occur within green coffee beans due to a roasting step in which the green coffee beans are heated. The green coffee bean roasting step is usually performed using hot air, direct firing, or the like at normal pressure.

The coffee flavor components generated over the course of the roasting step are then extracted and, e.g., added to canned coffee beverages.

However, the characteristic coffee tastes and aromas deteriorate over the course of time once the seal of the canned coffee beverage has been opened, because the coffee beverage within the can comes into contact with oxygen molecules in the air, and hydrogen peroxide is produced. The hydrogen peroxide that is produced oxidizes and degrades the coffee flavor components.

The addition of ascorbic acid or other antioxidants has accordingly been considered in addition to other means for reducing the rate of hydrogen peroxide generation, but the original coffee flavor must remain unaffected to the extent possible. Examinations have therefore been performed for limiting the generation hydrogen peroxide after seal breakage by adding chlorogenic acids, which are naturally included in green coffee beans and act as antioxidants, and increasing the content of chlorogenic acids in the coffee extract (see Patent Document 1).

“Chlorogenic acids” is a collective designation for esters of a cinnamic acid derivative and quinic acid. Chlorogenic acids are a type of polyphenol compound.

[Patent Document 1] Japanese Patent Application Laid-open No. 2003-204756

### DISCLOSURE OF THE INVENTION

### Problems that the Invention is Intended to Solve

Chlorogenic acids are not heat stable and are readily degraded by hydrolysis and heat. Chlorogenic acids generally make up approximately 5.5% to 8.0% of green coffee beans, but one half that amount or more is degraded and lost due to hot-air and other roasting processes.

Chlorogenic acids are conventionally extracted from an un-roasted plant containing chlorogenic acids (e.g., green coffee beans) by solvent extraction using ethanol, methanol, or other hydrophilic organic solvents or by supercritical fluid extraction or another specialized extraction method. Extracts containing chlorogenic acids are then added to extracts obtained from normal roasted coffee beans.

In other words, an extraction process for extracting chlorogenic acids must be performed separately from the manufacture of coffee beverages to obtain a chlorogenic acid extract, or green coffee bean extracts or other commercial products must be purchased in order to obtain chlorogenic acids.

In either case, extracting the chlorogenic acids, mixing the chlorogenic acids with extracts obtained from roasted coffee beans, and other labor is required, possibly leading to increases in equipment costs for extraction apparatuses, raw material costs for purchasing green coffee bean extracts or other commercial products, and other costs.

The present invention was devised in light of the aforementioned problems and provides a method of processing green coffee beans in which a coffee beverage containing a high concentration of chlorogenic acids is manufactured without the separate addition of chlorogenic acids.

### Means for Solving the Problems

A first characteristic configuration of the present invention for achieving the above object is a method of processing coffee beans in which green coffee beans are roasted and roasted coffee beans are obtained, wherein the green coffee beans are brought into contact with a high-temperature, high-pressure fluid and the roasting process is performed.

According to the first characteristic configuration, the green coffee beans are brought into contact with a high-temperature, high-pressure fluid and roasted. Roasting can therefore be performed in a short time period relative to conventional hot-air roasting performed at high temperature and normal pressure. Heat degradation of the chlorogenic acids included in the green coffee beans can therefore be kept to a minimum.

The process is performed at high temperature and pressure, and therefore the partial hydrolysis of polysaccharides, fiber materials, and other insoluble components of the green coffee beans is promoted, and fewer physical barriers to this process are presented, whereby an improvement is realized in terms of the efficiency with which chlorogenic acids, the various coffee flavor components, and other compounds generated by roasting are extracted. As a result, a stable, more richly flavored coffee extract in which little hydrogen peroxide is generated and flavor components are not readily oxidized due to the high concentration of chlorogenic acids can be obtained merely by subjecting roasted coffee beans to ordinary grinding and extraction.

Extracting chlorogenic acids separately from the manufacture of coffee beverages, or purchasing green coffee bean extracts or other commercial products to be added afterwards to the coffee extract is therefore not necessary, resulting in a simple and convenient method of processing green coffee beans. Cost increases are therefore not a problem, and cost reductions can also be expected in that electrical consumption and other running costs are reduced due to the shortened period of roasting, and raw material costs are reduced due to improvements in the utilization efficiency of raw materials (green coffee beans).

In a second characteristic configuration of the present invention, the roasting is performed at 100 to 230° C. using the high-temperature, high-pressure fluid.

According to the second characteristic configuration, the roasting of the green coffee beans can be more reliably performed in a short period of time.

When the temperature is less than 100° C., the processing time must be lengthened in order to generate the favorable roasted flavors that are characteristic of coffee. As a result, the chlorogenic acids will be more readily degraded by heat, the amount of chlorogenic acids in the roasted beans will decrease, and the amount of chlorogenic acids transferred to the coffee beverage will be reduced. When the temperature is higher than 230° C., many of the favorable roasted flavors will disperse, and the prevalence of burnt flavors will increase, which is not suitable for beverages.

In a third characteristic configuration of the present invention, the roasting is performed at 170 to 210° C.

According to the third characteristic configuration, heat degradation of chlorogenic acids can be limited and favorable roasted flavors can be obtained in the range of 170° C. to 210° C., especially.

In a fourth characteristic configuration of the present invention, the roasting is performed at a gauge pressure of 0.1 to 3.0 MPa.

According the fourth characteristic configuration, the roasting of the green coffee beans can be more reliably performed in a short period of time.

When the gauge pressure is less than 0.1 MPa, the reactions will require a long period of time, and therefore the chlorogenic acids will be degraded by heat, the amount of chlorogenic acids in the roasted beans will decrease, and the amount of chlorogenic acids transferred to the coffee beverage will be reduced.

On the other hand, when the pressure is higher than 3.0 MPa, the pressure within the reaction vessel will be difficult to control. Such pressure levels are therefore not suitable for the operation from the standpoint of handling.

In a fifth characteristic configuration of the present invention, the high-temperature, high-pressure fluid is a saturated steam.

According to the fifth characteristic configuration, the thermal conduction efficiency increases significantly (by a factor of approximately 10) over dry air (hot-air roasting). As a result, the roasting time can be shortened to approximately 30 seconds to 4 minutes using the present configuration, where the necessary processing time using hot-air roasting is usually 15 minutes to 30 minutes or more; however, this will depend on the desired degree of roasting (from light roasting to Italian roasting).

A sixth characteristic configuration of the present invention is a processed coffee bean product that is processed using the method of processing coffee beans according to any one of the first through fifth characteristic configurations.

According to the sixth characteristic configuration, roasted coffee beans can be provided containing large amounts of chlorogenic acids and other non-heat stable compounds in green coffee beans, having favorable roasted flavors that are characteristic of coffee, and having improved extraction efficiency.

A seventh characteristic configuration of the present invention is a coffee beverage wherein the processed coffee bean product according to the sixth characteristic configuration is used as a raw material.

Chlorogenic acids are a type of polyphenol and are well-known as a component having a function for removing oxygen radicals, which are thought to be a factor leading to cancer, arteriosclerosis, and other lifestyle-related diseases. The importance of dietary therapy, exercise therapy, limitations on alcohol and tobacco consumption, and other general therapies intended as lifestyle improvements has been recognized in relation to lifestyle-related diseases. Improved eating habits are said to be one of the most important such therapies, and research related to foods and beverages containing materials that function to remove oxygen radicals is flourishing.

According to the seventh characteristic configuration, chlorogenic acids are included at a high concentration, allowing the provision of a high-quality coffee beverage in which the generation of hydrogen peroxide is limited and in which the flavor is not lost for long periods even in, e.g., canned coffee beverages whose seals have been broken. In addition, chlorogenic acids, which have excellent biological functions (functions for removing oxygen radicals) in regard to cancer, arteriosclerosis, and other lifestyle diseases, can be included and ingested at high concentrations in coffee beverages, which are greatly enjoyed and regularly consumed throughout world, and therefore a large contribution can be made to the prevention of lifestyle-related diseases.

An eighth characteristic configuration of the present invention is roasted coffee beans having a degree of roasting of L18 to L23 and a chlorogenic acids content of 10 to 13 mg per gram.

The roasted coffee beans according to the eighth characteristic configuration can be obtained having a high concentration of chlorogenic acids even after being roasted to the degree used for coffee beverages. These roasted coffee beans are ideally used as raw materials for coffee beverages.

### BEST MODE FOR CARRYING OUT THE INVENTION

The present invention involves roasting green coffee beans using a high-temperature, high-pressure fluid. This roasting will be referred to as the “high-temperature, high-pressure process” in the present embodiment.

“Chlorogenic acids” in the present specification is a collective designation for esters of a cinnamic acid derivative and quinic acid. Examples include caffeoylquinic acids in which caffeic acid is ester-linked to one hydroxyl group in the third, fourth, or fifth position of quinic acid (e.g., 5-caffeoylquinic acid); dicaffeoylquinic acids in which caffeic acid is ester-linked to two hydroxyl groups in the third, fourth, or fifth positions of quinic acid (e.g., 3,4-dicaffeoylquinic acid), and feruloylquinic acids in which ferulic acid is ester-linked to one hydroxyl group in the third, fourth, or fifth position of quinic acid (e.g., 3-feruloylquinic acid).

One embodiment of the present invention involves performing the high-temperature, high-pressure process on green coffee beans and manufacturing a processed coffee bean product.

Examples of the variety of coffee may include arabica, robusta, and liberica.

“Green coffee beans” refers to dried seeds that have been purified after the pulp, skin, and other parts from harvested coffee cherries, which are the fruits of coffee trees, have been removed. The purifying step may involve washing with water, washing without water, or other processes.

Examples of liquids that may be used as the fluid employed in the high-temperature, high-pressure process include distilled water, desalinated water, tap water, alkali ion water, deep-sea water, ion-exchange water, deoxygenated water, and water containing water-soluble organic compounds (e.g., alcohol) or inorganic salts, but these examples are not given by way of limitation.

Examples of gases that may be used as the fluid employed in the high-temperature, high-pressure process include vapors of the aforementioned liquids, such as water and alcohol vapor. From the standpoint of workability and handleability, the steam is preferably saturated steam, but this case is not given by way of limitation.

Other than the fluids above, examples of the fluid employed in the high-temperature, high-pressure process include supercritical fluids or subcritical fluids. Once a specific temperature and pressure (critical point) are exceeded, the boundary between gas and liquid will dissipate, leaving a region where the fluid is sustained in a state in which both phases are blended together. Such a fluid is called a supercritical fluid. Supercritical fluids have high density and have properties somewhere between a gas and a liquid. Subcritical fluids are fluids in a state in which the pressure and temperature are below the critical point.

Examples of the method for supplying the high-temperature, high-pressure fluid include batch systems, in which the fluid is supplied to a pressure vessel, and a set processing time is maintained while the temperature and pressure are increased. Alternatively, in a continuous system, the fluid is made to flow for a set period of time in a pressure vessel from a fluid-supply pathway to a fluid-discharge pathway provided to the pressure vessel so that the fluid will be discharged from the fluid-discharge pathway at an exit pressure that is higher than atmospheric pressure. However, the method is not particularly limited as long as the pressure within the pressure vessel can be sustained.

The direction of flow when the fluid is supplied in a continuous system is not particularly limited. Examples include top to bottom, bottom to top, outside to inside, and inside to outside relative to the green coffee beans to be subjected to the high-temperature, high-pressure process.

The temperature during the high-temperature, high-pressure process is preferably approximately 100° C. to 230° C. In the present invention, it is necessary to hydrolyze polysaccharides and fiber materials, which are insoluble components of green coffee beans, and obtain soluble components; therefore, a relatively higher temperature of approximately 170° C. to 210° C. is particularly preferable.

The high-temperature, high-pressure process is preferably performed under pressurized conditions, and a gauge pressure of 0.1 to 3.0 MPa is particularly preferable. Saturated steam pressure is particularly preferred during high-temperature, high-steam processes. “Pressure” in the present specification refers to the “gauge pressure,” with atmospheric pressure as 0. Therefore, the conversion of, e.g., “a gauge pressure of 0.1 MPa” to absolute pressure would yield a pressure of 0.1 MPa plus atmospheric pressure. A gauge pressure of approximately 0.7 to 3.0 MPa is particularly preferable.

The processing time is preferably approximately 1 s to 60 min., and more preferably approximately 30 s to 4 min.

Well-known processes may also be performed after the high-temperature, high-pressure process in the present invention. Examples of well-known processes include grinding, extraction (including supercritical fluid extraction), and drying (vacuum drying and the like), but these cases are not given by way of limitation.

A processed coffee bean product that has been subjected to the high-temperature, high-pressure process in this manner is stored in a silo or the like using standard methods after being cooled and dried (vacuum drying, hot-air drying, or the like).

The resulting roasted coffee beans of the present invention will contain a high concentration of chlorogenic acids even after being subjected to roasting of the degree used for coffee beverages. Roasted coffee beans can be obtained, e.g., at a degree of roasting of L18 to L23 and having a chlorogenic acid content of approximately 10 mg to 13 mg per gram (see Example 1, described hereinafter).

A grinding step may also be performed before or during the high-temperature, high-pressure process. Uniform processing is thereby possible, the raw materials in the mixture can be mixed uniformly, and the high-temperature, high-pressure process of the present invention can also be uniformly performed. Molding of the high-temperature, high-pressure processed material of the present invention is also simplified. A mixing step may also be performed in addition to the grinding. The ground raw materials can thereby be uniformly mixed.

An extruder is preferably used in order to efficiently carry out the present invention. Operations after the aforedescribed process can thereby be greatly simplified. The use of an extruder is also suitable for supplying large amounts of processed products due to the fact that continuous processing is possible.

Extruders are often used in the manufacture of puffed foods and the like. An extruder is an apparatus with which raw materials are mixed, heated, pressurized, and extruded from a die in a high-temperature, high-pressure state using one or more screws positioned within an extrusion cylinder.

The twin-screw format is more preferable in the present invention due the fact that the high-temperature, high-pressure process can be stably performed thereby. Using an extruder allows continuous processing to be performed, and, if the pressure of the process atmosphere is suddenly reduced from a high to a low level the water will evaporate after processing.

A processed material that is molded into the desired shape can be obtained by appropriately selecting the shape of the aforedescribed die. Any apparatus other than those described above may also be used as long as the aforedescribed conditions of the present invention can be implemented.

The processed coffee bean product of the present invention is a raw material for coffee beverages and can be used together with roasted coffee beans, instant coffee, liquid coffee extracts, and the like when manufacturing coffee beverages in a factory using standard methods.

Examples of manufacturing steps for canning coffee beverages include “grinding,” “extracting,” “blending,” “filtering,” “filling,” “seaming,” “sterilizing,” “cooling,” and “boxing.” Alternatively, roasted coffee beans may be used, and instant coffee, liquid coffee extracts, or the like may be prepared.

### EXAMPLE 1

The present invention will be described more specifically below using examples, but the present invention is not limited to these examples.

Green coffee beans (arabica) were introduced into a pressure vessel having a fluid-inlet pipe and a fluid-outlet pipe. Steam was supplied using the fluid-inlet pipe, the valve of the fluid-outlet pipe was closed when the pressure within the vessel reached 1.3 MPa (190° C.), and this state was maintained for 1 to 10 minutes. The valve of the fluid-outlet pipe was then opened, the pressure was slowly released, and processed coffee bean products (Inventions 1 through 3) having a degree of roasting (L value) of 18 to 23 were obtained.

Green coffee beans (arabica) were subjected to hot-air roasting for 7 to 15 minutes using an ordinary electric roaster (hot-air roaster), and roasted coffee beans (Comparison Products 1 through 3) having L values of 18 to 23 were obtained.

The chlorogenic acids content was measured for the coffee beans of Present Inventions 1 through 3 and Comparison Products 1 through 3 (step for measuring chlorogenic acids).

After being ground in a mill, each sample was measured out in an amount of 0.2 g, and Soxhlet extraction was performed for 3 hours using 100 ml of 80% methanol as an extraction solvent. The chlorogenic acids were measured and evaluated by HPLC using the heated methanol extracts.

The chlorogenic acids were detected using HPLC (a UV 280-nm detector). The largest portion of the chlorogenic acids included in coffee is 5-caffeoylquinic acid, and therefore a calibration curve was created using 5-caffeoylquinic acid as a standard, and the chlorogenic acids were measured and evaluated.

TABLE 1

| | Green | | | | Comparison | Comparison | Comparison |
|---|---|---|---|---|---|---|---|
| Sample | coffee beans | Invention 1 | Invention 2 | Invention 3 | Product 1 | Product 2 | Product 3 |
| L value | 58 | 23 | 21 | 18 | 23 | 21 | 18 |
| Chlorogenic | 60.5 | 13.0 | 12.2 | 11.8 | 9.9 | 9.0 | 4.8 |
| acids | | | | | | | |
| content | | | | | | | |
| (mg/g) | | | | | | | |

As for results, the coffee beans of the present invention had a chlorogenic acids content of 10 mg/g or more and therefore clearly had a larger chlorogenic acids content than the coffee beans of the comparison examples. The fact that the loss of chlorogenic acids was minimized during the high-temperature, high-pressure process (roasting step) was therefore confirmed.

### EXAMPLE 2

The Present Invention 3 and the Comparison Product 3, which had the same L value (18), were used as samples. 30 g of each sample was measured out and ground in a mill. Extraction was performed in 450 g of hot water using a general commercial drip-style coffee maker. Coffee extracts (coffee beverages) were obtained, and the chlorogenic acid content was measured using HPLC. A sensory evaluation was performed on each sample by professional panelists.

TABLE 2

| Sample | Present Invention 3 | Comparison Product 3 |
|---|---|---|
| L value of processed | 18 | 18 |
| coffee bean product | | |
| Chlorogenic acid | 502 | 258 |
| content of coffee | | |
| beverage (ppm) | | |
| Aroma | A robust roasted aroma, | Along with the same |
| | along with a strong | roasted aroma of |
| | bean-like aroma. | Invention 3, a slightly |
| | | burnt aroma was |
| | | detected. |
| Flavor | Fruity and moderately | A clear, strongly |
| | acidic. A rich | acidic flavor. |
| | aftertaste. | |
| Color | A dark brown tinged | A dark brown. |
| | with red. | |

As for the results, the coffee beverage of the present invention exhibited a clear roasted flavor and a dark brown color, as did the coffee beverage of the comparison example, and had a fruity and somewhat acidic taste as well as a rich aftertaste. The coffee beverage of the present invention could therefore be said to have unique individual characteristics. The coffee beverage of the present invention was also free from, e.g., harsh and astringent flavors due to containing a large amount of chlorogenic acids relative to the comparison product.

The fact the processed coffee bean product of the present invention is a bean of a quality different from conventional roasted coffee beans was therefore confirmed.

### INDUSTRIAL APPLICABILITY

The present invention can be used as a method of processing coffee beans for roasting green coffee beans and obtaining roasted coffee beans.

1. A method of processing coffee beans in which green coffee beans are roasted and roasted coffee beans are obtained, wherein the green coffee beans are brought into contact with a high-temperature, high-pressure fluid and the roasting process is performed.

2. The method of processing coffee beans according to claim 1, wherein the roasting is performed at 100 to 230° C.

3. The method of processing coffee beans according to claim 2, wherein the roasting is performed at 170 to 210° C.

4. The method of processing coffee beans according to claim 1, wherein the roasting is performed at a gauge pressure of 0.1 to 3.0 MPa.

5. The method of processing coffee beans according to claim 1, wherein the fluid is a saturated steam.

6. A processed coffee bean product that is processed using the method of processing coffee beans according to claim 1.

7. A coffee beverage wherein the processed coffee bean product according to claim 6 is used as a raw material.

8. Roasted coffee beans having a degree of roasting of L18 to L23 and a chlorogenic acids content of 10 to 13 mg per gram.
